(19) United States
(12) Patent Application Publication
(10) Pub. No.: US 2006/0074672 A1
(43) Pub. Date: Apr. 6, 2006

(54) Speech synthesis apparatus with personalized speech segments

(75) Inventor: Eduardus Allefs, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTROINICS N.V., EINDHOVEN THE NETHERLANDS 5621 (NL)

(21) Appl. No.: 10/529,976

(22) PCT Filed: Sep. 12, 2003
(86) PCT No.: PCT/IB03/04035

§ 371 Date: Mar. 31, 2005

(30) Foreign Application Priority Data
Oct. 4, 2002 (EP) 02079127.3

(51) Int. Cl. G10L 13/00

(52) U.S. Cl. 704/258

(57) ABSTRACT

The present invention relates to a speech synthesis apparatus comprising:—means (102, 104) for inputting of natural speech,—means (106, 108, 110, 112, 113) for processing the natural speech to provide personalized speech segments (114),—means (118) for synthesizing of speech based on the personalized speech segments.

The present invention relates to the field of synthesizing of speech, and more particularly without limitation, to the field of text-to-speech synthesis.

The function of a text-to-speech (TTS) synthesis system is to synthesize speech from a generic text in a given language. Nowadays, TTS systems have been put into practical operation for many applications, such as access to databases through the telephone network or aid to handicapped people. One method to synthesize speech is by concatenating elements of a recorded set of subunits of speech such as demi-syllables or polyphones. The majority of successful commercial systems employ the concatenation of polyphones.

The polyphones comprise groups of two (diphones), three (triphones) or more phones and may be determined from nonsense words, by segmenting the desired grouping of phones at stable spectral regions. In a concatenation based synthesis, the conversation of the transition between two adjacent phones is crucial to assure the quality of the synthesized speech. With the choice of polyphones as the basic subunits, the transition between two adjacent phones is preserved in the recorded subunits, and the concatenation is carried out between similar phones. Before the synthesis, however, the phones must have their duration and pitch modified in order to fulfil the prosodic constraints of the new words containing those phones. This processing is necessary to avoid the production of a monotonous sounding synthesized speech. In a TTS system, this function is performed by a prosodic module. To allow the duration and pitch modifications in the recorded subunits, many concatenation based TTS systems employ the time-domain pitch-synchronous overlap-add (TD-PSOLA) (E. Moulines and F. Charpentier, “Pitch synchronous waveform processing techniques for text-to-speech synthesis using diphones,” Speech Commun., vol. 9, pp. 453-467, 1990) model of synthesis. In the TD-PSOLA model, the speech signal is first submitted to a pitch marking algorithm. This algorithm assigns marks at the peaks of the signal in the voiced segments and assigns marks 10 ms apart in the unvoiced segments. The synthesis is made by a superposition of Hanning windowed segments centered at the pitch marks and extending from the previous pitch mark to the next one. The duration modification is provided by deleting or replicating some of the windowed segments. The pitch period modification, on the other hand, is provided by increasing or decreasing the superposition between windowed segments. Example of such PSOLA methods are those defined in documents EP-0363233, U.S. Pat. No. 5,479,564, EP-0706170. A specific example is also the MBR-PSOLA method as published by T. Dutoit and H. Leich, in Speech Communication, Elsevier Publisher, November 1993, vol. 13, N. degree. 3-4, 1993. The method described in document U.S. Pat. No. 5,479,564 suggests a means of modifying the frequency by overlap-adding short-term signals extracted from this signal. The length of the weighting windows used to obtain the short-term signals is approximately equal to two times the period of the audio signal and their position within the period can be set to any value (provided the time shift between successive windows is equal to the period of the audio signal). Document U.S. Pat. No. 5,479,564 also describes a means of interpolating waveforms between segments to concatenate, so as to smooth out discontinuities. In prior art text-to-speech systems a set of pre-recorded speech fragments can be concatenated in a specific order to convert a certain text into natural sounding speech. Text-to-speech systems that use small speech fragments have many such concatenation points. TTS systems which are based on diphone synthesis techniques or unit selection synthesis techniques usually contain a database in which pre-recorded parts of voices are stored. These speech segments are used in the synthesis system to generate speech. Today's state of the art is that the recording of the voice parts takes place in a controlled laboratory environment because the recording activity is time consuming and requires voice signal processing expertise especially for manual post processing. Until now, such controlled environments can only be found at the suppliers of speech synthesis technology.

A common disadvantage of prior art TTS systems is that manufacturers of commercial products, such as consumer devices, who desire to integrate speech synthesis modules into such commercial or consumer products can only choose from a limited set of voices which are offered by the speech synthesis supplier. If a manufacturer requires a new voice it will have to pay the supplier for the expense of recording the required voice parts in the supplier's controlled environment and for the manual post processing. Prior art consumer products typically have only one voice or only a very limited set of voices the end-user can choose from. Examples of such consumer devices include audio, video, household, telecommunication, computer, personal digital assistants, car navigation and other devices.

The prior art such as U.S. Pat. No. 6,078,885 and U.S. Pat. No. 5,842,167 only provide very limited options for altering the provided speech synthesis system as far as expanding the dictionary is concerned and as far as adapting the voice as regards volume, speech and pitch are concerned. However, the voice as such cannot be altered in prior art systems.

It is therefore an object of the present invention to provide a speech synthesis apparatus and speech synthesis method which enables synthesizing of personalized speech.

The present invention provides for a speech synthesis apparatus which enables to synthesize personalized natural sounding speech. This is accomplished by inputting of natural speech into the speech synthesis apparatus, processing the natural speech to provide personalized speech segments, and using the personalized speech segments for speech synthesis.

The present invention is particularly advantageous in that it enables to provide a consumer device, such as a video, audio, household, telecommunication, personal digital assistant or car navigation device having a personalized speech synthesis capability. For example the end user of the consumer device can record his or her voice by means of the consumer device which then processes the voice samples to provide a personalized voice segments database. Alternatively the end user can have another person, such as a member of his or her family, to input the natural speech, such that the consumer device synthesizes speech which sounds like the voice of the particular family member.

For example, consumer devices like mobile phones, including DECT, GSM or corded phones can be equipped with a speech synthesis apparatus in accordance with the present invention to provide a personalized ‘voice’ to the phone. Likewise the user interfaces of other consumer devices like television sets, DVD players, personal computers and portable devices can be equipped with such a speech synthesis apparatus.

Some application examples are listed in the following:
Recording the voice of a family member in order to train the speech synthesis system. This enables speech synthesis of the text contained in emails which the family member sends to the user of the consumer device, such as a computer or a PDA, with the voice of that family member. In other words, an email which is received on the computer invokes a text-to-speech system in accordance with the invention. The source address of the email is used to select a corresponding personalized database of speech segments. Next the text contained in the email is synthesized by means of the selected personalized speech segments database. The synthesized speech output sounds as if the sender of the email would himself/herself read the text of the email to the receiver. Another application of making the database available to other users is exporting the personalized speech segments database and sending the personalized speech segments database to another user, such that when the user receives an email the text of the email is synthesized based on the personalized speech segments database. For example a user records his or her own voice, provides the personalized speech segments database to his or her family abroad, such that the family can hear the natural sounding synthesized voice of the user when the emails of that user are converted from text to speech by means of the speech synthesis system of the present invention
Recording of a child's voice and usage of the recorded voice in the speech synthesis module of a toy.
Usage of the personalized speech segments database of the invention for rendering of a digital representation of an audio and/or video program, such as a television program which is encoded as an MPEG file or stream, such as in digital audio and/or video broadcasting.
Downloading of a personalized speech segments database of celebrities such as pop stars, actors or politicians and use these personalized speech segments databases in the speech synthesis system of a commercial product.
Recording of the voice of a person for which it is known that he or she will loose his/her voice in the future as a result of a progressive disease such as throat cancer or another chronic disease affecting the muscles (like Multiple Sclerosis). The recorded voice elements can be processed and used in the speech synthesis part of communication equipment for the person having lost his or her voice.
Recording of the voice of one or more parents of a child and use the resulting personalized speech segment database(s) in electronic babycare products or toys equipped with a speech synthesis system.

It is to be noted that the present invention is not restricted to a certain kind of speech synthesis technology, but that any speech synthesis technology can be employed which synthesizes speech based on speech segments, such as by diphone, triphone, polyphone synthesis or unit selection techniques.

In accordance with a preferred embodiment of the invention nonsense carrier words are used to collect all diphones which are required for speech synthesis. For example, a diphone synthesis technique as disclosed in Isard, S., and Miller, D. Diphone synthesis techniques in Proceedings of IEE International Conference on Speech Input/Output (1986), pp. 77-82. can be used.

Alternatively natural carrier phrases can also be used, but the use of nonsense carrier words is preferred as it usually makes the delivery of the diphones more consistent. Preferably the nonsense carrier words are designed such that the diphones can be extracted from the middle of the word.

In accordance with a further preferred embodiment of the invention a pre-recorded and pre-processed database of speech segments is utilized. This speech segments database is provided as an integral part of the consumer device such that the consumer device already has a ‘voice’ directly after the manufacturing.

This speech segments database is utilized for generating a personalized speech segments database. This is done by finding a best match between a speech segment of the database and a corresponding speech segment which has been extracted from a recording of the end users voice. When such a best match has been found the marker information which is assigned to speech segment of the database is copied to the extracted speech segment. This way a manual post processing of the extracted speech segment for the purposes of adding marker information is avoided.

In accordance with a further preferred embodiment of the invention a technique which is called dynamic time warping (DTW) is used for finding the best match. By means of DTW the extracted speech segment is compared with its corresponding speech segment which is stored in the pre-recorded and pre-processed speech segments database by varying time/scale and/or amplitude of the signals in order to find the best possible match between them. For example, a pre-recorded speech segment, such as a diphone, having assigned marker information is aligned with a speech segment which is obtained from a corresponding nonsense word by means of DTW. For this purpose a technique as disclosed in Malfrer, F., and Dutoit, T. “High quality speech synthesis for phonetic speech segmentation” In Eurospeech 97 (Rhodes, Greece, 1997), pp. 2631-2634 can be utilized.

In accordance with a further preferred embodiment of the invention a user is prompted to speak a certain nonsense word by rendering of that nonsense word by means of a speech synthesis module. Preferably these prompts are generated at constant pitch and duration to encourage the speaker to do likewise. Further this makes is easier to find a best matching speech segment in the database as the speech segment in the database belonging to the spoken speech segment is pre-determined.

It is to be noted that the technique of DTW is as such known from Sakoe, H. & Chiba, S. (1978) “Dynamic programming algorithm optimization for spoken word recognition.” IEEE transaction. Acoustics, Speech, and Signal Processing 26. 43-49.

In accordance with a further preferred embodiment of the invention the consumer device has a user interface with a display for display of the list of nonsense words to be spoken by the user. Alternatively or in addition the user interface has an audio feedback functionality, such as rendering of audio prompts provided by the speech synthesizer. Preferably the user can select a nonsense word from the list which is then synthesized as a prompt for the user to repeat this nonsense word. When the user repeats the nonsense word this is recorded in order to obtain a corresponding speech segment. However, it is to be noted that such an user interface is not essential for the present invention and that the invention can also be realized without it.

It is to be noted that multiple personalized diphone databases can be advantageously used for other applications where synthesis of voices of multiple speakers is desired. Such a personalized diphone database can be established by the user by means of the consumer product of the invention or it can be provided by a third party, such as the original manufacturer, another manufacturer or a diphone database content provider. For example the diphone database content provider offers diphone databases for a variety of voices for download over the Internet.

In the following preferred embodiments of the invention will be described in greater detail by making reference to the drawings in which:

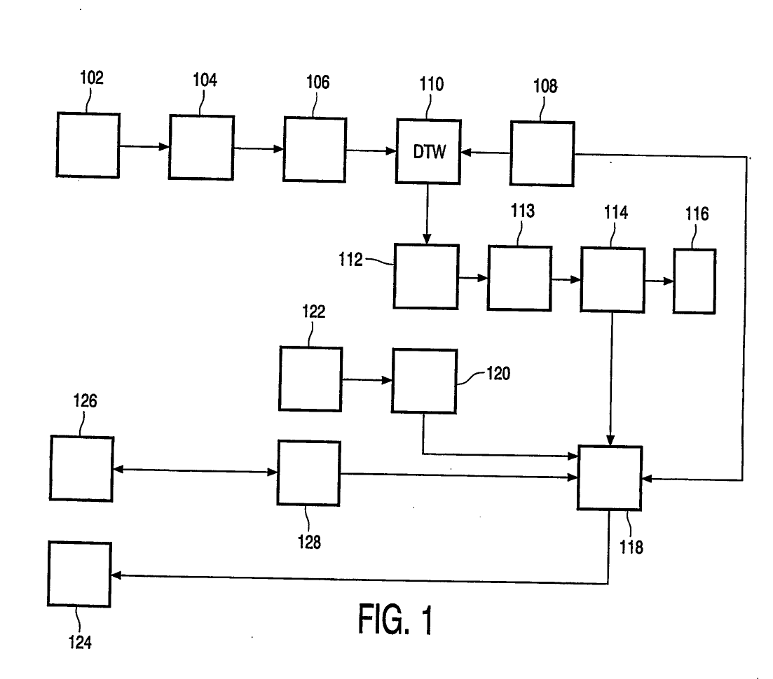

FIG. 1 is a block diagram of a first preferred embodiment of a speech synthesis apparatus of the present invention,

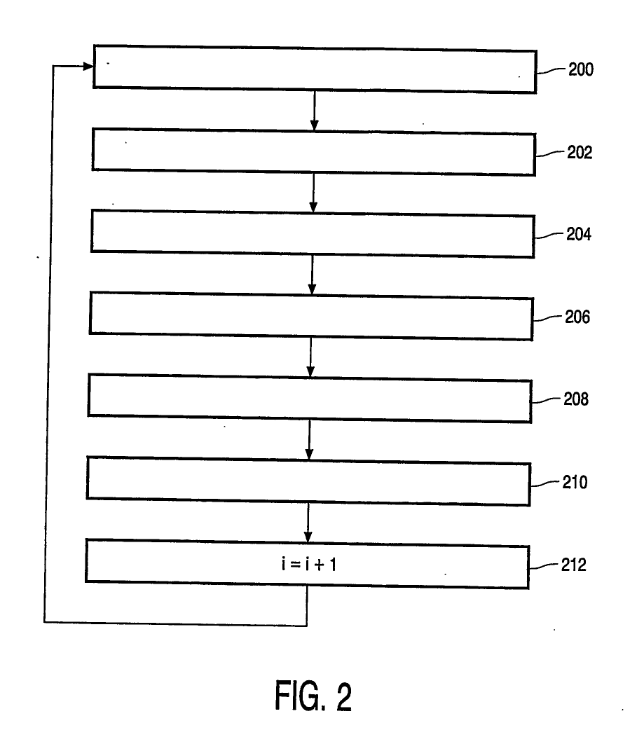

FIG. 2 is illustrative of a flow chart for providing a personalized speech database,

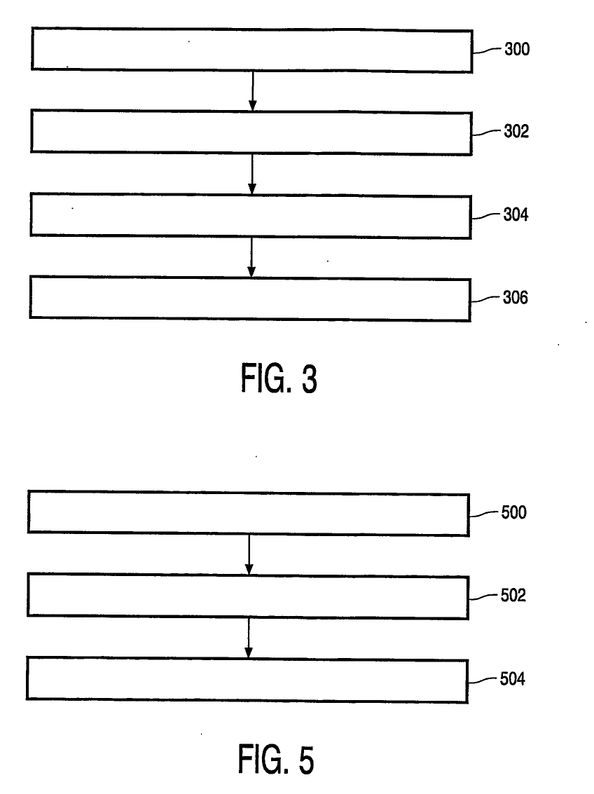

FIG. 3 is illustrative of a flow chart for personalized speech synthesis,

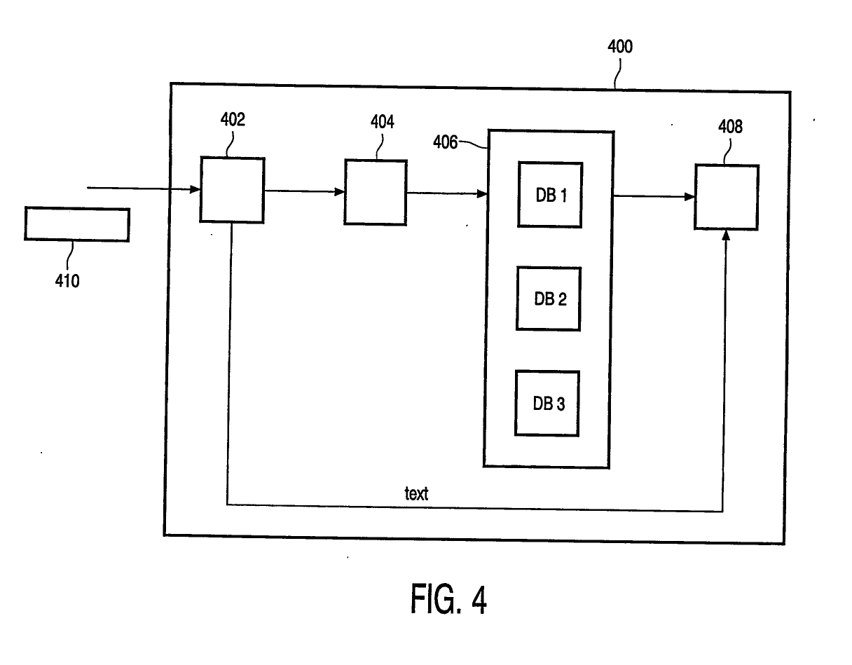

FIG. 4 is a block diagram of a further preferred embodiment of the invention,

FIG. 5 is illustrative of a flow chart regarding the operation of the embodiment of FIG. 4.

FIG. 1 shows a consumer device 100 with an integrated speech synthesizer. The consumer device 100 can be of any type, such as a household appliance, a consumer electronic device or a telecommunication or computer device. However, it is to be noted, that the present invention is not restricted to applications in consumer devices but can also be used for other user interfaces such as user interfaces in industrial control systems. The consumer device 100 has a microphone 102 which is coupled to voice recording module 104. Voice recording module 104 is coupled to temporary storage module 106. The temporary storage module 106 serves to store recorded nonsense words.

Further the consumer device 100 has a factory provided diphone database 108. Dynamic time warping (DTW) module 110 is coupled between temporary storage module 106 and diphone database 108. The diphone database 108 contains pre-recorded and pre-processed diphones having marker information assigned thereto. DTW module 110 is coupled to labeling module 112 which copies the marker information of a diphone from diphone database 108 after a best match between the diphone and the recorded nonsense word provided by temporary storage modulel06 has been found. The resulting labeled voice recording is inputted into diphone extraction module 113. The diphone provided by diphone extraction module 113 is then inputted into personalized diphone database 114. In other words, a voice recording stored in temporary storage module 106 is best matched with diphones contained in factory provided diphone database 108. When a best match has been found the label or marker information is copied from the best matching diphone of diphone database 108 to the voice recording by labeling module 112. The result is a labeled voice recording with the copied marker information. From this labeled voice recording the diphone is extracted and input into the personalized diphone database 114. This is done by diphone extraction module 113 which cuts out the diphones from the labeled voice recording. Personalized diphone database 114 is coupled to export module 116 which enables the exporting of the personalized diphone database 114 in order to provide it to another application or another consumer device. Further the consumer device 100 has a speech synthesis module 118. Speech synthesis module 118 can be based on any speech synthesis technology.

Speech synthesis module 118 has a text input module 120 which is coupled to controller 122. Controller 122 provides text to the text input module 120 which is then synthesized by means of speech synthesis module 118 and output by means of loudspeaker 124. Further the consumer device 100 has a user interface 126. User interface 126 is coupled to module 128 which stores a list of nonsense words which serve as carriers for inputting the required speech segments, i.e. diphones in the example considered here. The module 128 is also coupled to speech synthesis module 118. When the consumer device 100 is delivered to the end consumer the personalized diphone database 114 is empty. In order to give a personalized voice to consumer device 100 the user has to provide natural speech which forms the basis for filling the personalized diphone database 114 with corresponding speech segments which can then be used for personalized speech synthesis by speech synthesis module 118.

The input of speech is done by means of carrier words as stored in module 128. This list of carrier words is displayed on user interface 126. A nonsense word from the list stored in module 128 is inputted into speech synthesis module 118 in order to synthesis the corresponding speech. The user listens to the synthesized nonsense word and repeats the nonsense word by speaking it into microphone 102. The spoken word is captured by voice recording module 104 and the diphone of interest is extracted by means of diphone extraction module 106. The corresponding diphone within diphone database 108 and the extracted diphone provided by diphone extraction module 106 are compared by means of DTW module 110. DTW module 110 compares the two diphone signals by varying time/scale and/or amplitude of the signals in order to find the best possible match between them. When such a best match is found the marker information of the diphone of diphone database 108 is copied to the extracted diphone by means of labeling module 112. The labeled diphone with the marker information is then stored in personalized diphone database 114.

This process is carried out for all nonsense words contained in the list of words of module 128. When the entire list of words has been processed, personalized diphone database 114 is complete and can be utilized for the purpose of speech synthesis by speech synthesis module 118. When text is inputted into text input module 120 by controller 122 speech synthesis module 118 can utilize the personalized diphone database 114 in order to synthesis speech which sounds like the users voice.

By means of export module 116 the personalized diphone database 114 can be exported to provide it to another application or to another consumer device to give the users voice to the other application or consumer device.

FIG. 2 shows a corresponding flow chart illustrating the generation of personalized diphone database 114 of FIG. 1. In step 200 nonsense word i of the list of nonsense words is synthesized by means of the factory provided diphone database. In response the user repeats this nonsense word i and the natural speech is recorded in step 202. In step 204 the relevant diphone is extracted from the recorded nonsense word i. In step 206 a best match of the extracted diphone and the corresponding diphone of the manufacturer provided diphone database is identified by means of a DTW method.

When such a best match has been found the markers of the diphone of the factory provided diphone database are copied to the extracted diphone. The extracted diphone with the marker information is then stored in the personalized diphone database in step 210. In step 212 the index i is incremented in order to go to the next nonsense word on the list. From there the control goes back to step 200. This process is repeated until the whole list of nonsense words has been processed.

FIG. 3 is illustrative of a usage of the consumer device after the personalized diphone database has been completed. In step 300 a user can input his or her choice for the pre-set voice or the personalized voice, i.e. the manufacturer provided diphone database or the personalized diphone database. In step 302 text is generated by an application of the consumer device and provided to the text input of the speech synthesis module. Next in step 304 the speech is synthesized by means of the user selected diphone database and the speech is outputted by means of the loud speaker in step 306.

FIG. 4 shows an alternative embodiment for a consumer device 400. The consumer device 400 has an email system 402. The email system 402 is coupled to selection module 404. Selection module 404 is coupled to a set 406 of personalized diphone databases 1, 2, 3 . . . Each of the personalized diphone databases has an assigned source address, i.e. personalized diphone database 1 has source address A, personalized diphone database 2 has source address B, personalized diphone database 3 has source address C, . . .

Each of the personalized databases 1, 2, 3 . . . can be coupled to speech synthesis module 408. Each of the personalized diphone databases 1, 2, 3 . . . has been obtained by means of a method as explained with reference to FIG. 2. This method has been performed by consumer device 400 itself and/or one or more of the personalized diphone databases 1, 2, 3 . . . has been imported into the set 406.

For example the user B of consumer device 100 (cf. FIG. 1) exports its personalized diphone database and sends the personalized diphone database as an email attachment to consumer device 400. After receipt of the email by email system 402 the personalized diphone database is imported as personalized diphone database 2 with the assigned source address B into set 406.

In operation an email message 410 is received by the email system 402 of consumer device 400. The email message 410 has a source address, such as source address B, if user B has sent the email as well as the destination address of the user of consumer device 400. Further the email message 410 contains text in the body of the email message.

When the email message 110 is received by the email system 402 the selection module 404 is invoked. The selection 404 selects one of the personalized diphone databases 1, 2, 3 . . . of the set 406 which has a source address which matches the source address of the email message 410. For example if user B has sent the email message 410, selection module 404 selects personalized diphone database 2 within set 406.

The text contained in the body of the email message 410 is provided to speech synthesis module 408. Speech synthesis module 408 performs the speech synthesis by means of the personalized diphone database which has been selected by the selection module 404. This way the user of the consumer device 400 gets the impression, that the user B reads the text of the email to him or her.

FIG. 5 shows a corresponding flow chart. In step 500 an email message is received. The email message has a certain source address. In step 502 a personalized diphone database which is assigned to that source address is selected. If no such personalized diphone database has been previously imported the email is checked if it is has an attached personalized diphone database. If this is the case the personalized diphone database attached to the email is imported and selected. If no personalized diphone database having the assigned source address is available a default diphone database is chosen. Next the text contained in the body of the email is converted to speech by means of speech synthesis based on the selected personalized or default diphone database.

1. A speech synthesis apparatus comprising:
means for inputting of natural speech,
means for processing the natural speech to provide personalized speech segments,
means for synthesizing of speech based on the personalized speech segments.

2. The speech synthesis apparatus of claim 1, the means for processing the natural speech comprising means for extracting of speech segments from natural speech.

3. The speech synthesis apparatus of claim 1 further comprising:
a speech segments database for storing of speech segments, the speech segments having marker information assigned thereto,
means for finding a best match of a speech segment in the speech segments database and natural speech,
means for copying the marker information after the best match has been performed to the natural speech.

4. The speech synthesis apparatus of claim 3, the means for finding a best match being adapted to perform a dynamic time warping type method.

5. The speech synthesis apparatus of claim 1 further comprising a personalized speech segments database for storing of extracted speech segments, the extracted speech segments having marker information assigned thereto.

6. The speech synthesis apparatus of claim 1 further comprising means for storing a list of words to be spoken by a speaker to provide the personalized speech segments.

7. The speech synthesis apparatus of claim 1 further comprising a user interface for display of words to be spoken by a user.

8. The speech synthesis apparatus of claim 1 further comprising means for rendering of words to be spoken prior to inputting of the natural speech.

9. The speech synthesis apparatus of claim 1 further comprising:
a set of personalized speech segments databases for different speakers,
means for selecting one of the personalized speech segments databases from the set of personalized speech segments databases.

10. The speech synthesis apparatus of claim 1 further comprising means for exporting of the personalized speech segments.

11. The speech synthesis apparatus of claim 1, the natural speech to be inputted comprising a list of nonsense words.

12. The speech synthesis apparatus of claim 1, the speech segments being diphones, triphones and/or polyphones.

13. The speech synthesis apparatus of claim 1, the means for synthesizing of speech being adapted to perform the speech synthesis by means of a PSOLA type method.

14. The speech synthesis apparatus of claim 1, further comprising control means for providing text to the means for synthesizing of speech.

15. A consumer device, such as an audio, video, household, camera, computer, telecommunication, car navigation and/or personal digital assistant device, comprising a speech synthesis apparatus in accordance with claim 1 for providing of a personalized natural speech output.

16. A method of speech synthesis comprising the steps of:
inputting of natural speech into a consumer device,
processing of the natural speech by the consumer device to provide personalized speech segments,
synthesizing of text-to-speech to provide a personalized speech output based on the personalized speech segments for text to be outputted by the consumer device.

17. The method of claim 16 further comprising extracting of speech segments from the natural speech.

18. The method of claim 16 further comprising the steps of:
identifying a best matching speech segment for inputted natural speech in a database, the database comprising speech segments having marker information assigned thereto,
assigning the marker information of the identified best matching speech segment to the natural speech.

19. The method of claim 16, whereby a dynamic time warping type method is employed for identification of the best matching speech segment.

20. A computer program product, such as a digital storage medium, comprising computer program means for performing the steps of:
inputting of natural speech into a consumer device,
processing of the natural speech within the consumer device to provide personalized speech segments,
synthesizing of text-to-speech to provide a personalized speech output based on the personalized speech segments for text to be outputted by the consumer device.
